(19) United States
(12) Patent Application Publication
(10) Pub. No.: US 2002/0003510 A1
(43) Pub. Date: Jan. 10, 2002

(54) IMAGE DISPLAY APPARATUS AND METHOD FOR VEHICLE

(76) Inventor: TETSU SHIGETOMI, KANAGAWA (JP)

Correspondence Address: FROMMER LAWRENCE & HAUG, 745 FIFTH AVENUE- 10TH FL., NEW YORK, NY, 10151, US

(21) Appl. No.: 09/229,909

(22) Filed: Jan. 13, 1999

(30) Foreign Application Priority Data
Jan. 16, 1998 (JP) 10-007030
Jan. 16, 1998 (JP) 10-007031

(51) Int. Cl. G09G 3/00; G09G 3/36

(52) U.S. Cl. 345/31; 345/100

(57) ABSTRACT

An image display apparatus and an image display method for a vehicle provided for achieving stable image display in accordance with the velocity of the vehicle throughout the period in which the vehicle passes through the system installation section. An incoming velocity detector and an outgoing velocity detector are each provided at the ends of the system installation section. The velocity of a train is detected throughout the period in which the train passes through the system installation section. Display timing of display terminals is controlled in accordance with the detected velocity. As a result, even if the velocity of the train changes while the train passes through the system installation section, no drifts of the image viewed by the passenger on the train would result.

### BACKGROUND OF THE INVENTION

1. Field of the Invention

The present invention relates to an image display apparatus and an image display method for a vehicle that allow passengers on the vehicle to view a plurality of still-frame images provided along the moving direction of the vehicle with stability.

2. Description of the Related Art

In general station name displays and various types of advertisements are provided in a train or underground (subway) station, on the wall of a tunnel and so on. Since such displays are fixed to the wall, it is difficult for the passengers on a vehicle such as a train to view the displays with stability. An image display system has been therefore developed for placing a plurality of still image panels whose contents are the same or slightly different from one another along the moving direction of a train and intermittently illuminating the panels in unison in accordance with the movement of the train. The system allows the passengers on the vehicle to view the string of the still image panels as a still-frame image or a moving image with stability. Such a system is disclosed in, for example, Japanese Patent Publication Hei 7-117654 (1995) (Japanese Patent Application Laid-open Hei 5-27197 (1993)), Japanese Patent Application Laid-open Hei 5-40448 (1993), Japanese Patent Application Laid-open Hei 5-224617 (1993), Japanese Patent Application Laid-open Hei 2-201489 (1990), Japanese Patent Application Laid-open Hei 2-256090 (1990), and Japanese Patent Application Laid-open Hei 3-36515 (1991).

In such a system of related art, assuming that the speed of a vehicle passing through the system is maintained at a predetermined velocity, or in order to simplify the system configuration, whether the vehicle enters the section where the system is provided is only detected but the velocity of the vehicle is not detected. In such a case, however, the position in which the image is displayed when viewed by the passengers horizontally drifts and becomes unstable if the velocity of the vehicle changes from the estimated velocity.

In order to overcome the problem, a velocity sensor may be provided at one point in the system installation section (at the forward end, for example). Based on the velocity information obtained by the sensor, timing of still image panel illumination may be controlled. In the method illumination of the still frame panels is turned on and off with the optimal timing in accordance with the velocity as long as the velocity of the vehicle is detected. As a result, the image display position when viewed by the passengers on the vehicle is stabilized.

In the method, however, the velocity information is not obtained by the sensor in the period between the point in time at which the rearmost part of the vehicle passes over the sensor and the point at which the rearmost part passes over the backward end of the system installation section. In the period the operation is controlled based on the last velocity data obtained by the sensor. Therefore, if the velocity of the vehicle changes during the period between the point at which the rearmost part of the vehicle passes over the sensor and the point at which the rearmost part passes over the backward end of the system installation section, it is impossible to change on/ off timing of illumination of the still image panels in response to the change in velocity. Consequently, the image display position when viewed by the passengers on the vehicle horizontally drifts and becomes unstable.

### SUMMARY OF THE INVENTION

It is an object of the invention to provide an image display apparatus and an image display method for a vehicle that achieve stable image display in accordance with the velocity of the vehicle throughout the period in which the vehicle passes through the system installation section.

An image display apparatus for a vehicle of the invention comprises: a plurality of image display means placed in a row at specific intervals along a moving direction of the vehicle, each being capable of instantaneously displaying a still-frame image; a first velocity detection means, placed near the foremost part of the row of the image display means, for detecting a velocity of the vehicle; a second velocity detection means, placed near the rearmost part of the row of the image display means, for detecting a velocity of the vehicle; and a means for controlling timing of display of the still-frame images by the image display means, based on the velocity obtained by the first velocity detection means and the velocity obtained by the second velocity detection means. The image display means may be each capable of instantaneously displaying still-frame images forming a moving image in time sequence. The image display means may be each capable of instantaneously displaying still-frame images based on image information given as electrical information.

Another image display apparatus for a vehicle of the invention comprises: a plurality of image display means placed in a row at specific intervals along a moving direction of the vehicle, each being capable of instantaneously displaying a still-frame image; a first velocity detection means, placed near the foremost part of the row of the image display means, for detecting a velocity of the vehicle; a second velocity detection means, placed near the rearmost part of the row of the image display means, for detecting a velocity of the vehicle; a switch means for switching information to output from first velocity information obtained by the first velocity detection means to second information obtained by the second velocity detection means when the difference between the first velocity information and second velocity information falls within a specific range in accordance with a movement of the vehicle; and a means for generating and outputting a signal for controlling timing of displaying the still-frame images by the image display means, based on the first velocity information or the second velocity information selected and outputted by the switch means. The image display apparatus may further comprise a means for determining whether the velocity information outputted from the first and second velocity detection means is valid or not so that the velocity information that is determined as valid by the means for determining is only inputted to the switch means to effect switching. The image display means may be each capable of instantaneously displaying still-frame images forming a moving image in time sequence. The image display means may be each capable of instantaneously displaying still-frame images based on image information given as electrical information.

An image display method for a vehicle of the invention includes the steps of: placing a plurality of image display means in a row at specific intervals along a moving direction of the vehicle, each being capable of instantaneously displaying a still-frame image; placing a first velocity detection means for detecting a velocity of the vehicle near the foremost part of the row of the image display means and placing a second velocity detection means for detecting a velocity of the vehicle near the rearmost part of the row of the image display means; and controlling timing of display of the still-frame images by the image display means, based on the velocity obtained by the first velocity detection means and the velocity obtained by the second velocity detection means.

Another image display method for a vehicle of the invention includes the steps of: placing a plurality of image display means in a row at specific intervals along a moving direction of the vehicle, each being capable of instantaneously displaying a still-frame image; placing a first velocity detection means for detecting a velocity of the vehicle near the foremost part of the row of the image display means and placing a second velocity detection means for detecting a velocity of the vehicle near the rearmost part of the row of the image display means; switching information to output from first velocity information obtained by the first velocity detection means to second information obtained by the second velocity detection means when the difference between the first velocity information and second velocity information falls within a specific range in accordance with a movement of the vehicle, and outputting the second information; and generating and outputting a signal for controlling timing of displaying the still-frame images by the image display means, based on the first velocity information or the second velocity information outputted.

According to the image display apparatus or method of the invention, timing of display of the still-frame images by the image display means is controlled, based on the velocity obtained by the first velocity detection means placed near the foremost part of the row of the image display means and the velocity obtained by the second velocity detection means placed near the rearmost part of the row of the image display means. As a result, timing control of still-frame image display is achieved in accordance with the velocity of the vehicle throughout the period in which the vehicle passes through the section where the image display means are placed.

According to the other image display apparatus or method of the invention, information to output is switched from first velocity information obtained by the first velocity detection means placed near the foremost part of the row of the image display means to second information obtained by the second velocity detection means placed near the rearmost part of the row of the image display means when the difference between the first velocity information and the second velocity information falls within a specific range, and the second information is outputted. A signal for controlling timing of displaying the still-frame images by the image display means is generated, based on the first velocity information or the second velocity information outputted. That is, switching of the velocity information is performed and the signal for controlling timing is generated from the velocity information selected through switching. As a result, the interval of display timing instructed by the signal remains constant before and after the switching of information.

Other and further objects, features and advantages of the invention will appear more fully from the following description.

### BRIEF DESCRIPTION OF THE DRAWINGS

FIG. 1 is a block diagram of an image display apparatus for a vehicle of an embodiment of the invention.

FIG. 2 is a block diagram for illustrating the main configuration of each display terminal shown in FIG. 1.

FIG. 3 is a block diagram for illustrating the main configuration of the main controller shown in FIG. 1.

FIG. 4 is a block diagram for illustrating the main configuration of the incoming velocity detector shown in FIG. 1.

FIG. 5 is a view for illustrating the velocity detection principle of the incoming velocity detector.

FIG. 6 illustrates incoming velocity detection pulses outputted from the incoming velocity detector.

FIG. 7 is a table for describing the parameters required for practically arranging the image display apparatus shown in FIG. 1, giving specific values.

FIG. 8A to FIG. 8I illustrates the way a train passes through the system installation section.

FIG. 9 is a flowchart of the operation of the incoming velocity detector shown in FIG. 4.

FIG. 10 illustrates the way a moving image is viewed by the passengers on the train.

FIG. 11 is a block diagram for illustrating the main configuration of an incoming velocity detector of an image display apparatus for a vehicle of another embodiment of the invention.

FIG. 12 is a flowchart of the operation of the incoming velocity detector shown in FIG. 11.

FIG. 13 is a table for illustrating the operation of the switch of the incoming velocity detector in accordance with passing of the train.

FIG. 14 is a block diagram of a velocity sensor unit of an incoming velocity detector of an image display apparatus for a vehicle of another example of the invention.

FIG. 15A and FIG. 15B illustrate detection signals outputted from the two receptors of the velocity sensor unit shown in FIG. 14.

FIG. 16A to FIG. 16C are views for describing an effect in the embodiment shown in FIG. 11.

FIG. 17 is a view for describing the effect in the embodiment shown in FIG. 11.

### DETAILED DESCRIPTION OF THE PREFERRED EMBODIMENTS

Preferred embodiments of the invention will now be described in detail with reference to the accompanying drawings.

First Embodiment

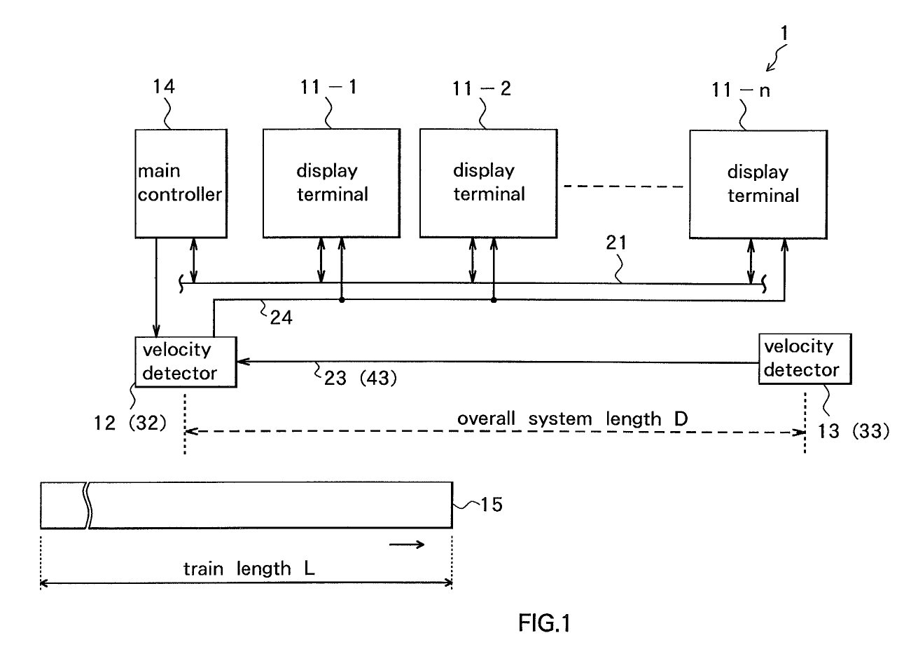

FIG. 1 is a schematic diagram of an image display apparatus for a vehicle of an embodiment of the invention. In the embodiment the image display apparatus is provided in a tunnel through which a train passes, for example. An image display method for a vehicle of an embodiment of the invention implemented by the image display apparatus of the embodiment will be described as well. As shown, an image display apparatus 1 for a vehicle comprises: a plurality of display terminals 11-1 to 11-n placed at specific intervals on the sidewall inside a tunnel along the moving direction of a train 5; an incoming velocity detector 12 provided near the foremost part of the installation section of the apparatus (where the train enters the tunnel); an outgoing velocity detector 13 provided near the rearmost part of the installation section of the apparatus (where the train goes out of the tunnel); and a main controller 14 for controlling the entire apparatus. In the embodiment the distance between the incoming velocity detector 12 and the outgoing velocity detector 13 (overall system length D) is equal to or shorter than overall length L of the train 15 (about 100 meters, for example). The display terminals 11-1 to 11-n correspond to ‘image display means’ of the invention. The incoming velocity detector 12 corresponds to a ‘first velocity detection means’ of the invention. The outgoing velocity detector 13 corresponds to a ‘second velocity detection means’ of the invention.

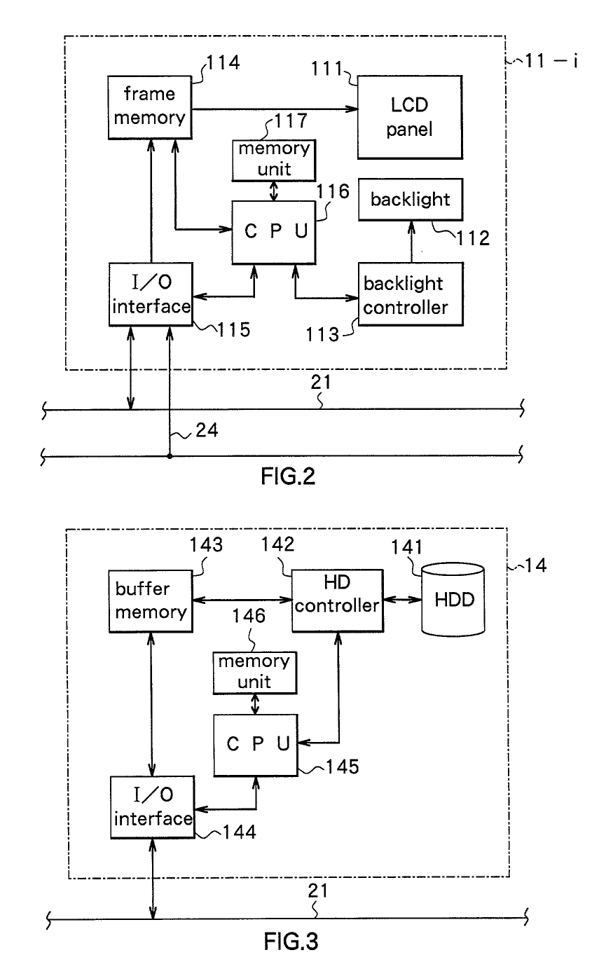

The display terminals 11-1 to 11-n each have the configuration as shown in FIG. 2 described later and instantaneously display various types of still-frame images. Instantaneous display means display performed in a period as short as one thirtieth of a second, for example. The display terminals 11-1 to 11-n are connected to the main controller 14 through a data and control line 21. Through the data and control line 21 the display terminals 11-1 to 11-n receive various types of still-frame image data and undergo control of the main controller 14. In addition, the display terminals 11-1 to 11-n receive light-emission timing pulses 24 from the incoming velocity detector 12.

The main controller 14 has the configuration as shown in FIG. 3 described later and holds various types of still-frame image data. When necessary, the main controller 14 supplies still-frame images identical with one another or still-frame images different from one another to the display terminals 11-1 to 11-n through the data and control line 21. The main controller 14 is connected to the incoming velocity detector 12 as well and controls the operation of the detector 12.

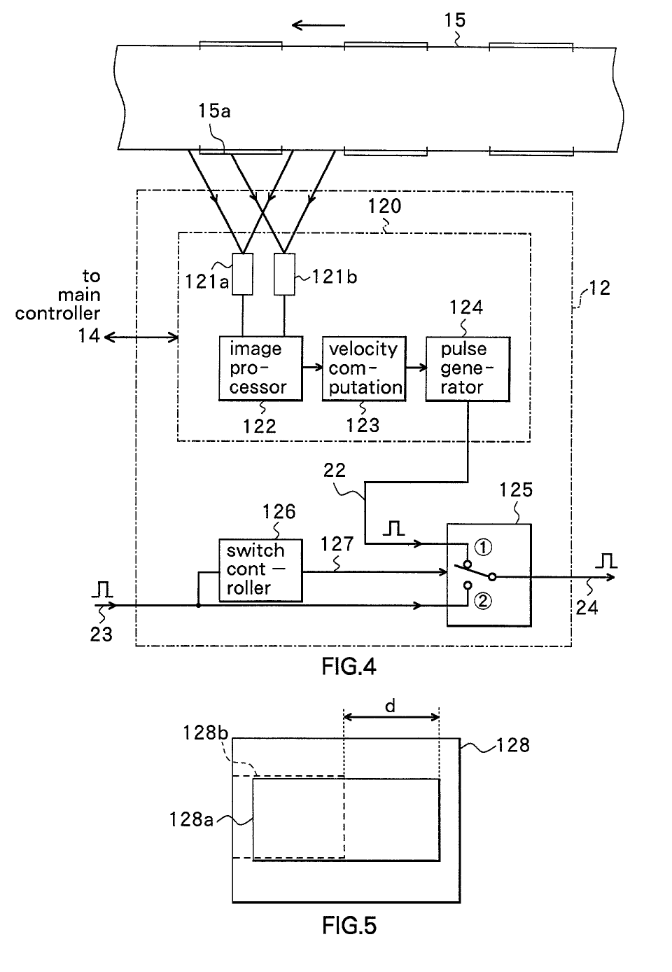

The incoming velocity detector 12 has the configuration as shown in FIG. 4 described later and continuously detects the velocity of the train 15 and generates incoming velocity detection pulses 22 (not shown in FIG. 1) having a cycle responsive to the detected velocity. The outgoing velocity detector 13 continuously detects the velocity of the train 15 and generates outgoing velocity detection pulses 23 having a cycle responsive to the detected velocity and sends the pulses 23 to the incoming velocity detector 12. As will be described later, the incoming velocity detector 12 selects either the pulses 22 generated by itself or the pulses 23 inputted from the outgoing velocity detector 13 and outputs the selected pulses as timing pulses 24. Part of the incoming velocity detector 12 that mainly performs the selection processing described above and the timing pulses 24 correspond to ‘means for controlling timing’ of the invention.

FIG. 2 illustrates the configuration of each of the display terminals 111 to 11-n. Although the ith display terminal 11-i is shown (where i=any of 1 to n), the other display terminals 11-1 to 11-n each have a similar configuration. The display terminal 11-i comprises: a liquid crystal display (LCD) panel 111 for displaying a still-frame image; a backlight 112 for illuminating the LCD panel 111; a backlight controller 113 for controlling the illuminating operation of the backlight 112; a frame memory 114 capable of retaining still-frame image data for one frame; an input/ output interface 115 for exchanging still-frame image data and control data with the data and control line 21 and for performing input processing of the timing pulses 24; a central processing unit (CPU) 116 for controlling the display terminal 11-i as a whole; and a memory unit 117 made up of a read only memory (ROM) retaining a program for operation of the CPU 116, a random access memory (RAM) used as a work memory for the CPU 116 and so on. The LCD panel 111 is placed on the sidewall inside the tunnel in the position corresponding to the vertical position of a window of the train 15.

In the display terminal 11-i having such a configuration, compressed still-frame image data for one frame sent from the main controller 14 through the data and control line 21 undergoes signal processing such as expansion by the input/ output interface 115 and is stored in the frame memory 114 and further supplied to the LCD panel 111 under the control of the CPU 116. The input/ output interface 115 receives the timing pulses 24 from the incoming velocity detector 12, performs signal processing on the pulses such as waveform shaping, and supplies the pulses to the CPU 116. The CPU 116 controls the backlight controller 113 based on the inputted timing pulses 24. The backlight controller 113 controls on and off of the backilight 112 (intermittent instantaneous light-emission control) in synchronization with the timing pulses 24. As a result, a still-frame image corresponding to the still-frame image data supplied from the frame memory 114 is instantaneously displayed on the LCD panel 111 in an intermittent manner with timing synchronized with the timing pulses 24.

FIG. 3 illustrates the configuration of the main controller 14. The main controller 14 comprises: a hard disk drive (HDD) 141 for retaining still-frame image data and moving image data; an HDD controller 142 for controlling recording and replaying of data in the HDD 141; a buffer memory 143 for preliminarily storing image data replayed from the HDD 141 or image data to record in the HDD 141; an input/output interface 144 for exchanging image data and control data with the data and control line 21; a CPU 145 for controlling the main controller 14 as a whole; and a memory unit 146 made up of a ROM retaining a program for operation of the CPU 145, a RAM used as a work memory for the CPU 145 and so on.

In the main controller 14 having such a configuration, still-frame image data or moving image data supplied from an external device not shown through the data and control line 21 undergoes specific signal processing by the input/output interface 144 under the control of the CPU 145. The data is then preliminarily stored in the buffer memory 143 and recorded in the HDD 141 by the HDD controller 142 under the control of the CPU 145. If necessary, the CPU 145 performs control of replaying still-frame image data from the HDD 141 by the HDD controller 142 and storing the data in the buffer memory 143 and then sending the data from the input/output interface 144 through the data and control line 21 to the display terminals 11-1 to 11-n. In this case, to show the passengers on the train 15 (FIG. 1) a still-frame image, the same still-frame image data is sent to all the display terminals 11-1 to 11-n. To show the passengers on the train 15 a moving image, still-frame image data items different from one another for ‘n’ frames forming a sequential moving image are each sent to the respective display terminals 11-1 to 11-n.

FIG. 4 is a schematic view of the incoming velocity detector 12 together with the train 15. The velocity detector 12 comprises a velocity sensor unit 120, a switch 125 and a switch controller 126. The velocity sensor unit 120 includes: two cameras 121a and 121b each for shooting an image of a window 15a of the train 15 running; an image processor 122 for performing specific image processing on the two image data items inputted from the cameras 121a and 121b; a velocity computation section 123 for determining the velocity of the train 15 based on the result obtained by the image processor 122; and a pulse generator 124 for generating and outputting the incoming velocity detection pulses 22 whose cycle corresponds to the computation result obtained by the velocity computation section 123. The switch 125 selects either the incoming velocity detection pulses 22 outputted from the pulse generator 124 of the velocity sensor unit 120 or the outgoing velocity detection pulses 23 outputted from the outgoing velocity detector 13 (FIG. 1) and outputs the selected pulse as the timing pulses 24. The switch controller 126 observes the input start timing of the velocity detection pulse 23 from the velocity detector 13, and controls the switch 125 to switch from position 1 (the detection pulse 22) to position 2 (the detection pulse 23) at the instant of detecting input of the specific number of the detection pulses 23 (such as three pulses).

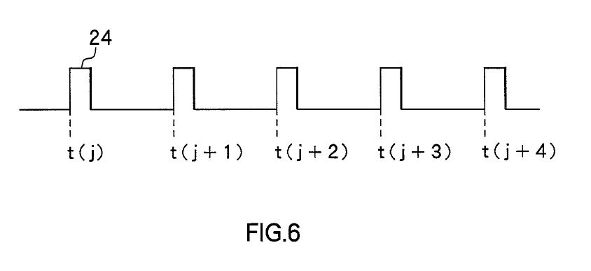

As shown, the cameras 121a and 121b are placed with the space narrower than the width of the window 15a of the train 15 and sequentially shoot the side of the train 15 running. The images taken by the cameras are superimposed on one another at the image processor 122. As shown in FIG. 5, for example, an image 128a of the window 15a taken by the camera 121a is superimposed on an image 128b of the same window 15a taken by the camera 121b in a single image frame 128. The image processor 122 detects distance ‘d’ between the two images. The velocity computation section 123 finds out the velocity of the train 15 based on detected distance d. The pulse generator 124 generates and outputs the incoming velocity detection pulses 22, as shown in FIG. 6, having a cycle corresponding to the computation result. Although the velocity sensor unit 120 operates the cameras 121a and 121b and performs shooting and detects the velocity only when a sensor not shown is detecting the presence of the train 15, shooting may be constantly performed.

The outgoing velocity detector 13 includes a velocity sensor unit similar to the velocity sensor unit 120 shown in FIG. 4 of the incoming velocity detector 12. The velocity detector 13 detects the velocity of the train 15, outputs the velocity detection pulses 23 having a cycle corresponding to the detected velocity, and sends the pulses to the velocity detector 12.

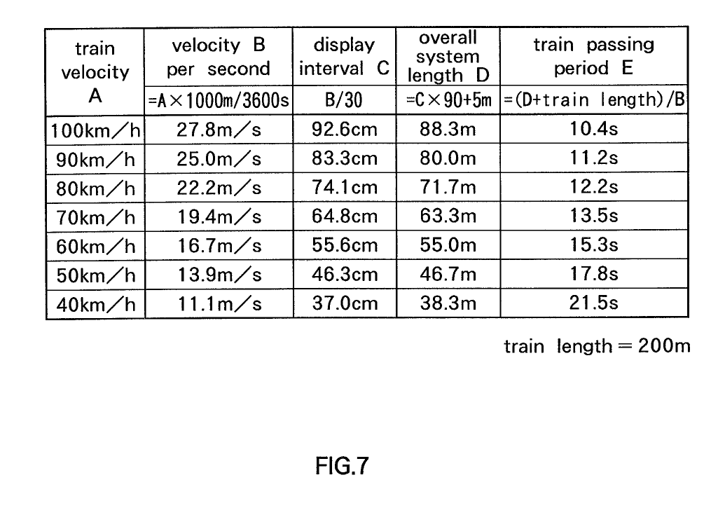

Reference is now made to FIG. 7 for describing the parameters required for practically arranging the image display apparatus 1, giving specific values. In general a moving image manipulated by a television set of the National Television System Committee (NTSC) system is made up of thirty still-frame images per second. Each of the still-frame images is the image of each instant of a continuous moving image changing with time. If a person observes the still-frame images at the display rate of thirty images per second, the person recognizes the images as a continuous moving image due to the afterimage effect. Utilizing the principle, the apparatus of the invention splits a moving image of three seconds, for example, into ninety still-frame images and displays the images each on the LCD panel 111 of the respective display terminals 11-1 to 11-n in the order started from the terminal 11-1 on the incoming side of the train 15. The backlights 112 are instantaneously turned on in an intermittent manner in response to the velocity of the train 15. As a result, the passenger on the train 15 observes a moving image of three seconds in a specific fixed position through the window.

Assuming that a moving image is made up of thirty still-frame images per second as described above, the relationship among velocity A per hour and velocity B per second of the train, interval C among the display terminals 11-1 to 11-n, overall system length D, and train passing period E may be as shown in FIG. 7, where overall length L of the train 15 is 200 meters, for example. Interval C among the display terminals 11-1 to 11-n is determined by B/30. Overall system length D is determined by C×90+5. Period E required for the train to pass through the system is determined by (D+train length)/B. For example, if the train velocity is 60 km per hour, interval C is 55.6 cm, overall system length D is 55 m, and train passing period E is 15.3 seconds.

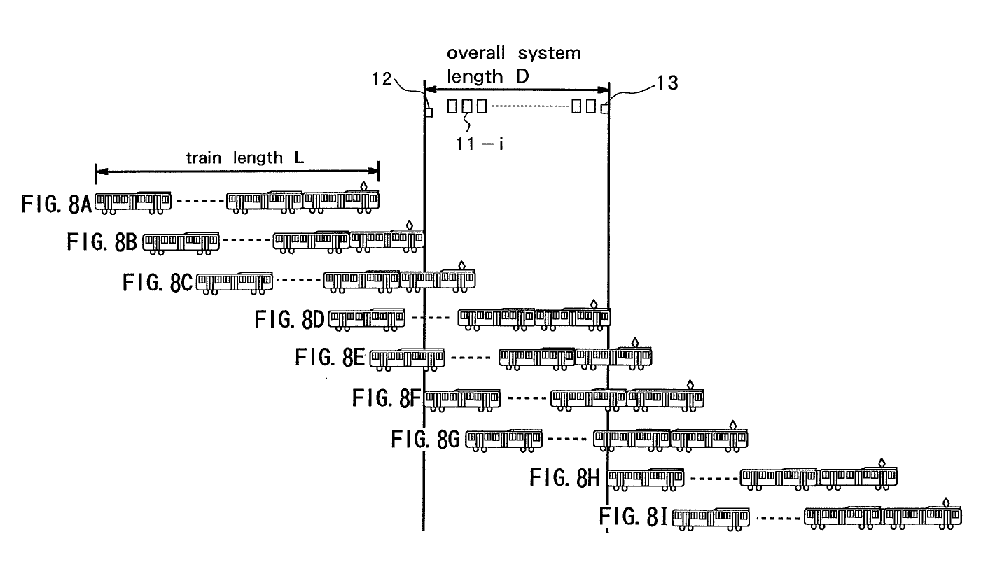

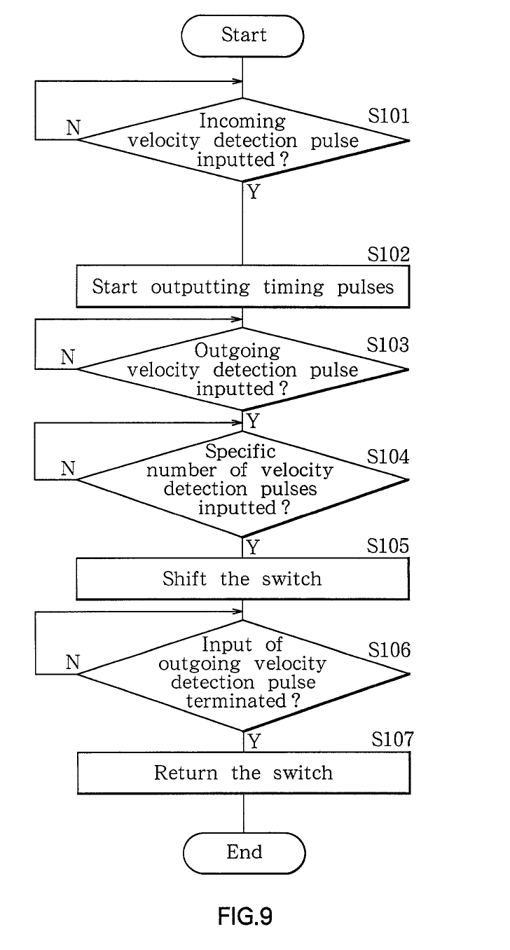

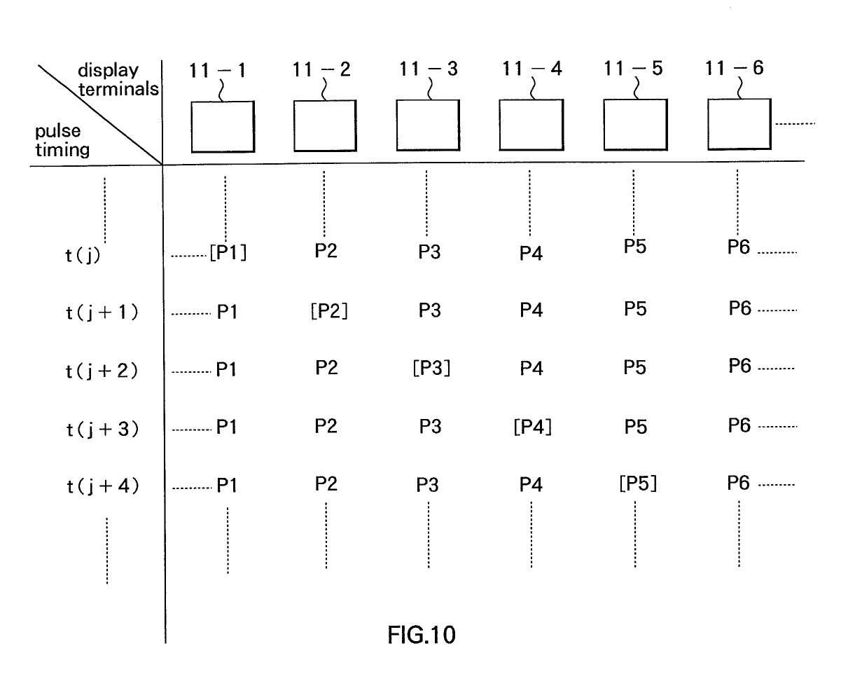

Reference is now made to FIG. 8A to FIG. 8I through FIG. 10 for describing the operation of the image display apparatus for a vehicle having the configuration thus described. FIG. 8A to FIG. 8I illustrate the way the train 15 passes through the system installation section. FIG. 9 illustrates the operation of the incoming velocity detector 12 shown in FIG. 4. FIG. 10 illustrates the way a moving image is observed by the passengers on the train 15. In the following description the display terminals 11-1 to 11-n are assumed to have received still-frame image data items from the main controller 14 and retain the data items in the respective frame memories 114.

Referring to FIG. 8A to FIG. 8I, the way the train 15 passes through the system installation section will now be described. In FIG. 8A to FIG. 8I the train 15 enters the system installation section at the left of the drawing and goes to the right. At the point of FIG. 8A the train 15 has not reached the system installation section yet and the incoming velocity detector 12 does not detect the train 15. When the train 15 comes to the point of FIG. 8B, the velocity detector 12 detects the entry of the train 15 and starts detecting the velocity thereof. The train 15 further advancing through the point of FIG. 8C and reaching the point of FIG. 8D, the outgoing velocity detector 13 detects the train 15 and starts detecting the velocity thereof. The train 15 further advancing through the point of FIG. 8E and reaching the point of FIG. 8F, the velocity detector 12 terminates detection of the velocity of the train 15. From then on the velocity is detected by the velocity detector 13 only. Therefore, the velocity of the train 15 is detected by both of the detectors 12 and 13 in the period between the point of FIG. 8D and the point of FIG. 8F. The train 15 further advancing through the point of FIG. 8G and reaching the point of FIG. 8H, the velocity detector 13 terminates detection of the velocity of the train 15. The train 15 then leaves the system installation section as shown in FIG. 8I.

Referring to FIG. 9, the main operation of the incoming velocity detector 12 will now be described. When the train 15 comes to the point of FIG. 8B, the velocity sensor unit 120 of the velocity detector 12 starts the operation of velocity detection. The image processor 122 performs image processing on the images taken by the cameras 121a and 121b and determines distance d shown in FIG. 5. The velocity computation section 123 determines the velocity of the train 15 from distance d obtained at the image processor 122 and sends the result to the pulse generator 124. Based on the velocity data obtained, the pulse generator 124 determines the timing interval of image display (the cycle of intermittent display) in the display terminals 11-1 to 11-n. The pulse generator 124 then outputs the incoming velocity detection pulses 22 whose pulse interval (pulse cycle) is equal to the timing interval. If the velocity of the train 15 is higher than the reference velocity (the estimated velocity), the pulse generator 124 determines the pulse interval shorter than the length corresponding to the reference velocity. If the velocity of the train 15 is lower than the reference velocity, the pulse generator 124 determines the pulse interval longer than the length corresponding to the reference velocity.

In the initial state the switch 125 shown in FIG. 4 of the velocity detector 12 is set to position 1. Consequently, if the detection pulses 22 whose cycle (pulse interval) corresponds to the velocity of the train 15 are outputted from the velocity sensor unit 120 and inputted to the switch 125 (Y of step S101 of FIG. 9), the switch 125 starts outputting the detection pulses 22 as they are as the timing pulses 24 (step S102).

The timing pulses 24 are supplied to the display terminals 11-1 to 11-n (FIG. 1). In the display terminals 11-1 to 11-n, the backlights 112 turn on and off in unison in synchronization with the timing pulses 24. Intermittent instantaneous display is thereby started in unison in all the display terminals 11-1 to 11-n.

The train 15 then advancing to the point of FIG. 8D, the velocity sensor unit (not shown) of the outgoing velocity detector 13 starts the operation of velocity detection and outputs the outgoing velocity detection pulses 23 whose pulse interval corresponds to the velocity of the train 15. The operation of velocity detection is similar to that of the velocity sensor unit 120 of the velocity detector 12 and description thereof is omitted. The detection pulses 23 outputted from the velocity detector 13 are sent to the velocity detector 12 (FIG. 4) and then inputted to the switch controller 126 and the switch 125.

The switch controller 126 of the velocity detector 13 monitors whether the velocity detection pulses 23 are inputted (step S103). If the switch controller 126 detects input of the pulses 23 (Y of step S103), the switch controller 126 waits until the inputted pulses reach the specific number (N of step S104). When the inputted pulses reach the specific number (three, for example) (Y of step S104), the switch controller 126 sends a switching signal 127 to the switch 125. On receiving the switch signal 127, the switch 125 switches the input from position 1 to position 2 (step S105). From then on the velocity detection pulses 23 are outputted as they are as the timing pulses 24. Accordingly, the timing pulses 24 generated based on the velocity detected by the velocity detector 13 are supplied to the display terminals 111 to 11-n (FIG. 1) from then on. In response to the timing pulses 24 intermittent instantaneous display is performed in all the display terminals 11-1 to 11-n in unison.

The switch controller 126 continues monitoring whether the velocity detection pulses 23 are inputted (step S106). If the switch controller 126 detects input of the pulses 23 is terminated (Y of step S106), the switch controller 126 outputs the switching signal 127 and returns the switch 125 to position 1 (step S107).

As thus described, the velocity detection pulses 22 and 23 outputted from the velocity detectors 12 and 13 are switched as the train 15 advances and the pulses are used as the timing pulses 24. Display timing control of the display terminals 11-1 to 11-n is thereby performed.

Reference is now made to FIG. 10 for describing the way a moving image is observed by the passenger on the train 15. In FIG. 10 the horizontal direction indicates the arrangement of the display terminal 11-i. The vertical direction indicates the rising point (instantaneous display point) ‘t(j)’ (where ‘j’ is an integer) of the timing pulses 24 shown in FIG. 6. At the intersection of the vertical and horizontal, still-frame image P(i) displayed on the LCD panel 111 (FIG. 2) at each point is indicated. As shown, the LCD panel 111 of the i^{th} display terminal 11-i instantaneously displays the same still-frame image P(i) at points to), t(j), t(j+1), t(j+2) and so on. Since the display points correspond to the velocity of the train 15, consecutive still-frame images [P1], [P2], [P3] and so on are displayed in the same position through the window when viewed by the passenger on the train 15. The still-frame images are observed as a sequential moving image due to the afterimage effect. In this case, the velocity detector 13 continues detecting the velocity of the train 15 after the rearmost part of the train 15 passes over the velocity detector 12. As a result, display timing of the display terminals 11-1 to 11-n changes in response to a change in velocity that may occur after the rearmost part of the train 15 passes over the velocity detector 12. Therefore horizontal drifts of the moving image when viewed by the passenger are prevented. In FIG. 10, if the contents of still-frame images P(i) are all identical, the image observed by the passenger on the train 15 is a still-frame image.

According to the image display apparatus for a vehicle of the embodiment thus described, the incoming velocity detector 12 and the outgoing velocity detector 13 are each provided at the ends of the system installation section. The velocity of the train 15 is detected throughout the period in which the train 15 passes through the system installation section. Display timing of the display terminals 11-1 to 11-n is controlled in accordance with the detected velocity. As a result, even if the velocity of the train 15 changes while the train 15 passes through the system installation section, no drifts of the image viewed by the passenger on the train will result. That is, the image is displayed in a stable position in response to the velocity of the train 15 throughout the period in which the train 15 passes through the system installation section. For example, the apparatus is suitable for commercials that requires high-quality image display since the image is displayed in a stable position when viewed by the passengers.

Second Embodiment

Another embodiment of the invention will now be described.

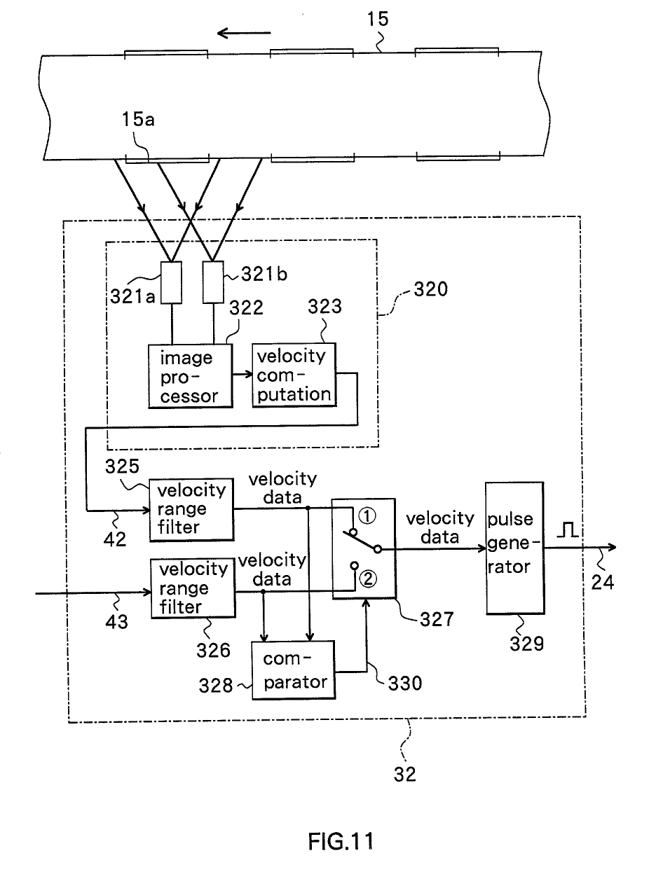

FIG. 11 is a schematic view of an incoming velocity detector 32 of an image display apparatus for a vehicle of the second embodiment of the invention together with the train 15. The velocity detector 32 comprises a velocity sensor unit 320, two velocity range filters 325 and 326, a switch 327, a comparator 328, and a pulse generator 329. The velocity sensor unit 320 has a configuration similar to that of the velocity sensor unit 120 shown in FIG. 4 except that the sensor unit 320 does not include the pulse generator 124. The sensor unit 320 includes: two cameras 321a and 321b each for shooting an image of the window 15a of the train 15 running; an image processor 322 for performing specific image processing on the two image data items inputted from the cameras 321a and 321b; a velocity computation section 323 for determining the velocity of the train 15 based on the result obtained by the image processor 322 and outputting the result as incoming velocity data 42.

The velocity range filter 325 outputs the velocity data 42 as it is only when the value of the velocity data 42 outputted from the velocity sensor unit 320 falls within a specific range. The filter 325 outputs ‘0’ when the velocity data 42 falls outside the range. The velocity range filter 326 outputs outgoing velocity data 43 as it is only when the value of the velocity data 43 outputted from an outgoing velocity detector 33 falls within a specific range. The filter 326 outputs ‘0’ when the velocity data 43 falls outside the range. The filters 325 and 326 are provided for using valid data only so as to prevent a malfunction due to noise and so on. Valid data is an item of data having a validity or a significance in contrast to invalid data resulting from noise and so on. The velocity range filters 325 and 326 correspond to ‘means for determining’ of the invention.

The switch 327 selects either the incoming velocity data 42 outputted from the velocity sensor unit 320 and inputted to position 1 through the filter 325 or the outgoing velocity data 43 outputted from the outgoing velocity detector 33 (FIG. 1) and inputted to position 2 through the filter 326. The switch 327 then supplies the selected data to the pulse generator 329.

The comparator 328 compares the value of the velocity data 42 having passed the filter 325 to the value of the velocity data 43 having passed the filter 326. When the difference between the values falls within a specific range, the comparator 328 controls the switch 327 to switch from position 1 (the velocity data 42) to position 2 (the velocity data 43). The switch 327 and the comparator 328 of the incoming velocity detector 32 mainly correspond to ‘switch means’ of the invention.

Based on the velocity data 42 or 43 inputted from the switch 327, the pulse generator 329 generates the timing pulses 24 (FIG. 6) whose cycle corresponds to the velocity data. The pulse generator 329 corresponds to ‘means for generating and outputting a signal’ of the invention.

The outgoing velocity detector 33 (FIG. 1) includes a velocity sensor unit similar to the velocity sensor unit 320 of the incoming velocity detector 32 shown in FIG. 11. The velocity detector 33 detects the velocity of the train 15 and outputs the detected velocity as the velocity data 43. The velocity data 43 is inputted to the velocity range filter 326 of the incoming velocity detector 32.

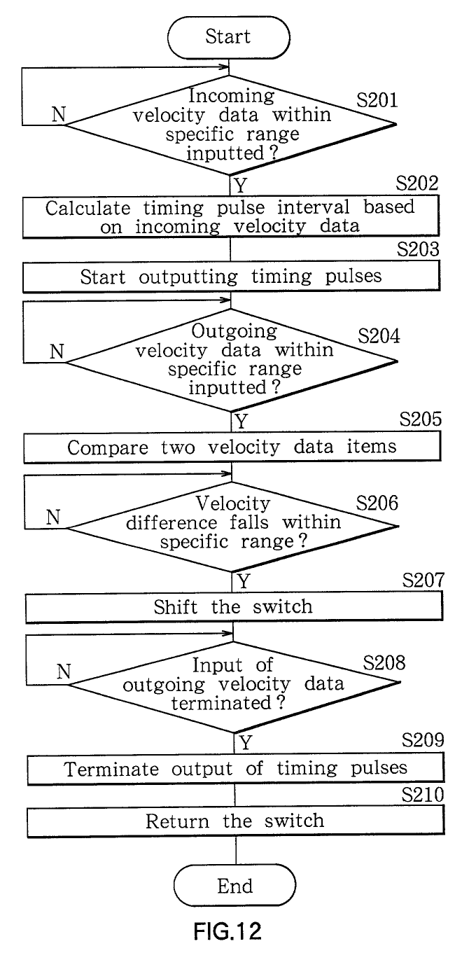

Referring to FIG. 12, the main operation of the incoming velocity detector 32 shown in FIG. 11 will now be described. When the train 15 comes to the point of FIG. 8B, the velocity sensor unit 320 of the velocity detector 32 starts the operation of velocity detection. The image processor 322 performs image processing on the images taken by the cameras 321a and 321b and determines distance d shown in FIG. 5. The velocity computation section 323 determines the velocity of the train 15 from distance d obtained at the image processor 322 and outputs the result as the velocity data 42.

The velocity range filter 325 determines whether the value of the inputted velocity data 42 falls within the specific range. If the value falls within the range (Y of step S201 of FIG. 12), the filter 325 outputs the value as it is. Since the switch 327 of the velocity detector 32 is set to position 1 in the initial state, the velocity data 42 outputted from the velocity sensor unit 320 and passing through the filter 325 is inputted to the pulse generator 329 through the switch 327.

Based on the inputted velocity data 42, the pulse generator 329 determines the timing interval of image display (the cycle of intermittent display) in the display terminals 11-1 to 11-n (step S202). The pulse generator 329 then starts outputting the timing pulses 24 whose pulse interval is equal to the timing interval (step S203). As in the foregoing embodiment, if the velocity of the train 15 is higher than the reference velocity (the estimated velocity), the pulse generator 329 determines the pulse interval shorter than the length corresponding to the reference velocity. If the velocity of the train 15 is lower than the reference velocity, the pulse generator 329 determines the pulse interval longer than the length corresponding to the reference velocity.

The timing pulses 24 are supplied to the display terminals 11-1 to 11-n (FIG. 1). In the display terminals 11-1 to 11-n, the backlights 112 start turning on and off in unison in synchronization with the timing pulses 24. Intermittent instantaneous display is thereby started in unison in all the display terminals 11-1 to 11-n.

The train 15 then advancing to the point of FIG. 8D, the velocity sensor unit (not shown) of the outgoing velocity detector 33, too, starts the operation of velocity detection and outputs the outgoing velocity detection data 43. The operation of velocity detection is similar to that of the velocity sensor unit 320 of the velocity detector 32 and description thereof is omitted. The velocity data 43 outputted from the velocity detector 33 is sent to the velocity detector 32 (FIG. 11) and then inputted to the filter 326.

The filter 326 determines whether the value of the inputted velocity data 43 falls within the specific range. If the value falls within the range (Y of step S204), the filter 126 outputs the value as it is.

The comparator 328 compares the value of the velocity data 42 outputted from the filter 325 to the value of the velocity data 43 outputted from the filter 326 (step S205). When the difference between the values falls within a specific range (plus and minus 1 km per hour, for example) (Y of step S206), the comparator 328 sends a switching signal 330 to the switch 327. On receiving the switching signal 330, the switch 327 switches input from position 1 to position 2 (step S207). From then on the timing pulses 24 are generated and outputted based on the velocity data 43. Accordingly, the timing pulses 24 generated based on the velocity data 43 detected by the velocity detector 33 are supplied to the display terminals 11-1 to 11-n (FIG. 1) from then on. In response to the timing pulses 24 intermittent instantaneous display is performed in all the display terminals 11-1 to 11-n in unison.

The comparator 328 continues monitoring whether the outgoing velocity data 43 is inputted (step S208) after the input of the incoming velocity data 42 is terminated. If the comparator 328 detects input of the data 43 is terminated (Y of step S208), output of the timing pulses 24 is terminated (step S209). The comparator 328 outputs the switching signal 330 and returns the switch 327 to position 1 (step S210).

As thus described, the velocity data 42 is switched to the velocity data 43 as the train 15 advances. Based on the switched velocity data the timing pulses 24 are generated and supplied to the display terminals 11-1 to 11-n. Display timing control is performed in response to the timing pulses 24.

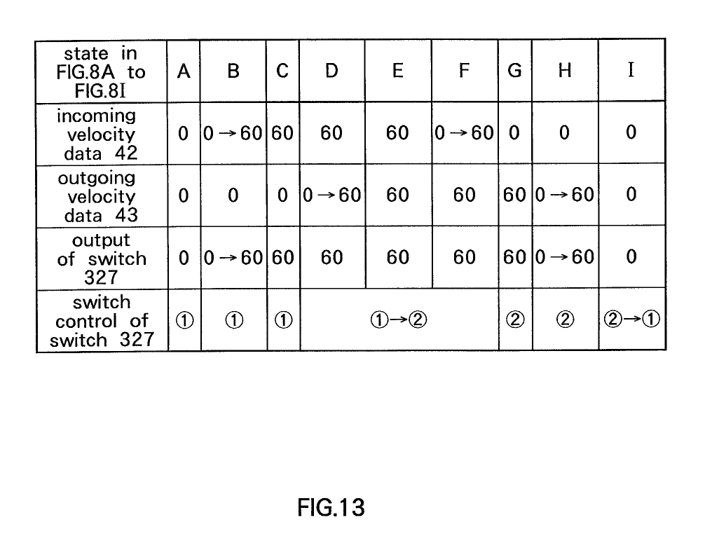

FIG. 13 is a table specifically indicating the operation of the switch 327 (FIG. 11) in accordance with passing of the train 15. The velocity of the train 15 passing is assumed to be 60 km per hour. As shown, when the train 15 reaches the state of FIG. 8B, the incoming velocity data 42 changes from ‘0 km’ to ‘60 km’. When the train 15 reaches the state of FIG. 8F, the velocity data 42 changes from ‘60 km’ to ‘0 km’. When the train 15 reaches the state of FIG. 8D, the outgoing velocity data 43 changes from ‘0 km’ to ‘60 km’. When the train 15 reaches the state of FIG. 8H, the velocity data 43 changes from ‘60 km’ to ‘0 km’. The switch 327 is set to position 1 and outputs the velocity data 42 when the train 15 reaches the states of FIG. 8A to FIG. 8C. The switch 327 is then switched from position 1 to position 2 at any point in the period between the states of FIG. 8D and FIG. 8F. The output thereof is thereby changed from the velocity data 42 to the velocity data 43. As a result, the output of the switch 327 is maintained at ‘60 km’ in the period between the states of FIG. 8D and FIG. 8F. The switch 327 is maintained at position 2 and outputs the velocity data 43 in the period between the states of FIG. 8G and FIG. 8H. The switch 327 is again switched from position 2 to position 1 in the state of FIG. 8I when the train 15 completely passes through the system installation section.

According to the image display apparatus for a vehicle of the second embodiment of the invention thus described, as in the foregoing first embodiment, the incoming velocity detector 32 and the outgoing velocity detector 33 are each provided at the ends of the system installation section. The velocity of the train 15 is detected throughout the period in which the train 15 passes through the system installation section. Display timing of the display terminals 11-1 to 11-n is controlled in accordance with the detected velocity. As a result, even if the velocity of the train 15 changes while the train 15 passes through the system installation section, no drifts of the image viewed by the passenger on the train will result. That is, the image is displayed in a stable position in response to the velocity of the train 15 throughout the period in which the train 15 passes through the system installation section.

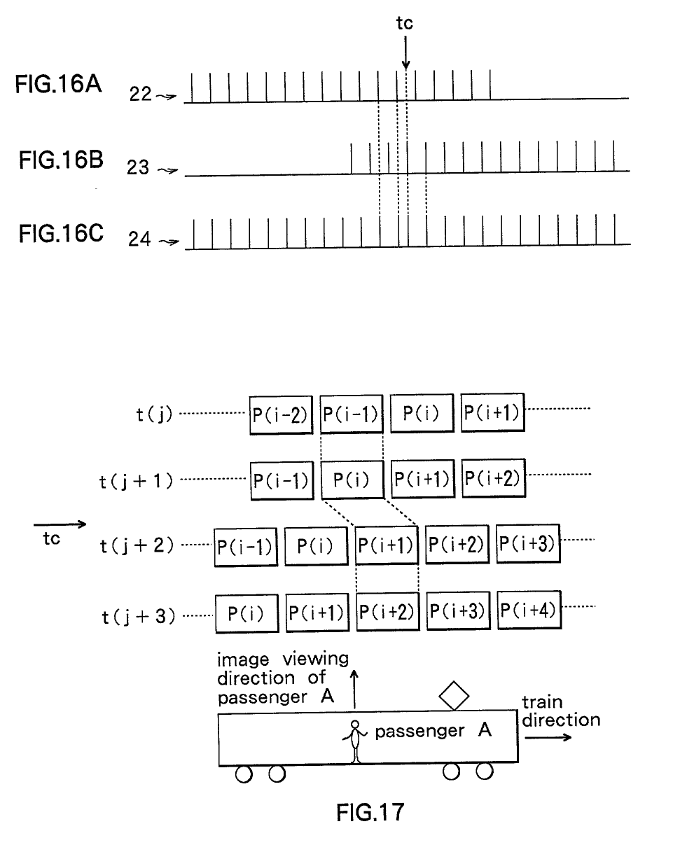

In the image display apparatus of the foregoing first embodiment, the velocity detection pulses 22 outputted from the velocity detector 12 are directly switched to the velocity detection pulses 23 outputted from the velocity detector 13 to output as the timing pulses 24. Consequently, the pulse phase may change at the point of switching as shown in FIG. 16A to FIG. 16C. This is because the pulse phases are not necessarily equal although the pulse cycles are equal. FIG. 16A illustrates the incoming velocity detection pulses 22. FIG. 16B illustrates the outgoing velocity detection pulses 23. FIG. 16C illustrates the timing pulses 24.

If the pulse phase changes after switching point ‘tc’ from the velocity detection pulses 22 to the velocity detection pulses 23, display timing in the display terminals 11-1 to 11-n changes. Consequently, as shown in FIG. 17, for example, the display position of the image appears to shift to the right or the left at a specific point (switching point tc) for the passenger on the train 15. As shown in FIG. 17, passenger A observes with time still-frame images P(i-1), P(i), P(i+1), P(i+2), and so on in sequence at each of display points t(j), t(j+1), t(j+2), t(j+3), and so on, in order started from the upper part towards the lower part of FIG. 17. Since display point t(j+2) immediately after switching point tc is earlier than the original display point (before switching), the display position of still-frame image P(i+1) at display point t(j+2) appears to shift to the right of FIG. 17.

In the image display apparatus of the second embodiment, switching of pulses is not performed in contrast to the foregoing image display apparatus. Instead, switching is performed on the velocity data outputted from the velocity sensor unit 320 and so on (that is, the velocity data 42 and 43) and then the timing pulses 24 are generated. As a result, the pulse phase will not change at the point of switching. The image display apparatus of the second embodiment therefore prevents the phenomenon that the image display position appears to shift to the right or the left at some point for the passenger on the train 15. More stable image display is thus achieved.

The invention is not limited to the foregoing embodiments but may be practiced in still other ways. For example, although the display terminals 11-1 to 11-n made up of the LCD panels are provided as the image display means in the foregoing embodiments, light-emitting diode (LED) panels made up of a plurality of LEDs may be used. Instead of such an electronic display device that performs display based on electrical image information, the image display means may be made up of still-frame images such as paintings or photographs printed on recording media such as paper or film, for example, and illumination devices for illuminating the images.

Although in the foregoing embodiments the switch 125 and the switch controller 126 (or the switch 327 and the comparator 328) are incorporated in the incoming velocity detector 12 (or 32), the switches and so on may be incorporated in the main controller 14 and the timing pulses 24 may be outputted from the main controller 14.

Although the two cameras are used in the velocity sensor unit in the foregoing embodiments, any other sensor such as a transmission light sensor, a reflection light sensor, or an ultrasonic sensor utilizing the Doppler effect may be applied.

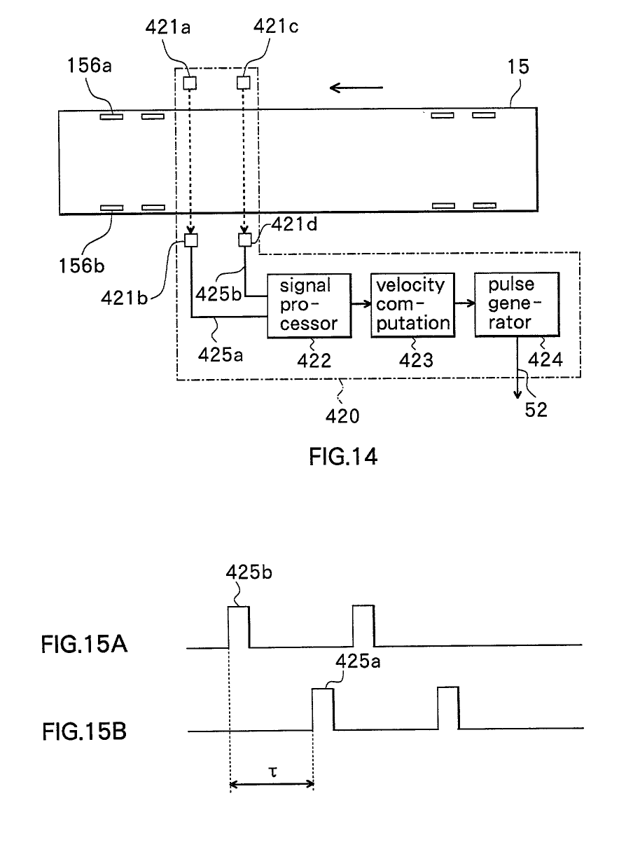

FIG. 14 illustrates an example of a velocity sensor unit 420 of the incoming velocity detector, using two pairs of transmission light sensors. The velocity sensor unit 420 comprises: a first transmission light sensor made up of an emitter 421a and a receptor 421b placed to sandwich the passage of the train 15; a second transmission light sensor made up of an emitter 421c and a receptor 421d placed in a similar manner with the specific space from the first transmission light sensor; a signal processor 422 for performing specific signal processing on detection signals 425a and 425b outputted from the receptors 421b and 421d; a velocity computation section 423 for determining the velocity of the train 15 based on the output of the signal processor 422; and a pulse generator 424 for generating incoming velocity detection pulses 52 based on the output of the velocity computation section 423. The two transmission light sensor each outputs the pulseshaped detection signals 425a and 425b as shown in FIG. 15A and FIG. 15B, respectively, when a pair of wheels 156a and 156b of the train 15 pass over the optical path and intercept the light. The signal processor 422 detects pulse interval τ (FIG. 15) of the detection signals 425a and 425b resulting from the passing of the pair of wheels. The velocity computation section 423 finds out the velocity of the train 15 based on pulse interval τ. The pulse generator 424 generates the velocity detection pulses 52 based on the obtained velocity and inputs the pulses to the switch 125 (FIG. 4). In FIG. 14 the switch 125 and the switch controller 126 are omitted. The velocity sensor unit of the outgoing velocity detector may have a similar configuration. In such a configuration no expensive television camera and complicated image processing are required so that the costs are reduced. In this case, as in the foregoing second embodiment (FIG. 11), the pulse generator 424 may be removed from the velocity detector 420 and the timing pulses 24 may be generated after switching the velocity data.

In the image display apparatus of the foregoing embodiments, if the train length is shorter than the overall system length, a period in which no velocity detection pulse (or velocity data) is outputted from either the incoming velocity detector 12 (or 32) or the outgoing velocity detector 13 (or 33) may result. However, if the difference between the train length and the overall system length is slight, such a period is short and the possibility that a change in velocity occurs during the period is reduced. Therefore, in such a non-detection period, there is no serious problem in controlling display timing by using the velocity detection pulse (or velocity data) last outputted from the velocity detector 12 (or 32).

For showing moving images or still-frame images the passengers for a long period of time as in the case of the train passing through a long tunnel, the image display apparatus shown in FIG. 1 may be provided as a unit and a plurality of the units may be connected to one another.

Although the image display apparatus is placed in a tunnel in the foregoing embodiments, the apparatus may be provided in any other place. For example, the apparatus may be installed in any place along the railroad and used at night. Furthermore, the apparatus may be used for not only the train or underground (subway) but also any other type of vehicle that carries passengers. For example, the apparatus may be applied to vehicles as attractions in an amusement park and the like. The system that gives the passengers a fantastic or thrilling feeling of virtual reality may be thereby implemented.

According to the image display apparatus or method of the invention thus described, timing of display of the still-frame images by the image display means is controlled, based on the velocity obtained by the first velocity detection means placed near the foremost part of the row of the image display means and the velocity obtained by the second velocity detection means placed near the rearmost part of the row of the image display means. As a result, timing control of still-frame image display is achieved in accordance with the velocity of the vehicle nearly throughout the period in which the vehicle passes through the section where the image display means are placed. Therefore, even if the velocity of the vehicle changes while the vehicle passes through the section, image display by the image display means is performed with timing corresponding to the change in velocity. The image viewed by the passenger on the vehicle is thereby stabilized.

In the image display apparatus, the distance between the position where the first velocity detection means is placed and the position where the second velocity detection means is placed may be shorter than the length of the vehicle. As a result, the period in which the velocity of the vehicle is not detected is eliminated when the vehicle passes through the section where the image display means are placed. The image viewed by the passenger on the vehicle is thereby stabilized throughout the period in which the vehicle passes through the section.

The image display means may be each capable of instantaneously displaying still-frame images forming a moving image. As a result, the passenger on the vehicle is allowed to view the moving image with stability.

The image display means may be each capable of instantaneously displaying still-frame images based on image information given as electrical information. As a result, images to display may be easily changed.

According to the other image display apparatus or method of the invention, information to output is switched from first velocity information obtained by the first velocity detection means placed near the foremost part of the row of the image display means to second information obtained by the second velocity detection means placed near the rearmost part of the row of the image display means when the difference between the first velocity information and the second velocity information falls within a specific range, and the second information is outputted. A signal for controlling timing of displaying the still-frame images by the image display means is generated, based on the first velocity information or the second velocity information outputted. As a result, the interval of display timing instructed by the signal remains constant before and after the switching of information and smooth switching is achieved. Therefore sudden horizontal shifts of the image position viewed by the passenger on the vehicle are prevented. Stable image display is thus provided for the passenger nearly throughout the period in which the vehicle passes through the section where the image display means are placed.

The image display apparatus may further comprise a means for determining whether the velocity information outputted from the first and second velocity detection means is valid or not so that the velocity information that is determined as valid by the means for determining is only inputted to the switch means to effect switching. A malfunction due to noise and so on is thereby prevented. As a result, reliability of the operation is further improved.

Obviously many modifications and variations of the present invention are possible in the light of the above teachings. It is therefore to be understood that within the scope of the appended claims the invention may be practiced otherwise than as specifically described.

What is claimed is:

1. An image display apparatus for a vehicle, comprising:
a plurality of image display means placed in a row at specific intervals along a moving direction of the vehicle, each being capable of instantaneously displaying a still-frame image;
a first velocity detection means, placed near the foremost part of the row of the image display means, for detecting a velocity of the vehicle;
a second velocity detection means, placed near the rearmost part of the row of the image display means, for detecting a velocity of the vehicle; and
a means for controlling timing of display of the still-frame images by the image display means, based on the velocity obtained by the first velocity detection means and the velocity obtained by the second velocity detection means.

2. An image display apparatus according to claim 1 wherein the distance between the position where the first velocity detection means is placed and the position where the second velocity detection means is placed is shorter than the length of the vehicle.

3. An image display apparatus according to claim 1 wherein the image display means are each capable of instantaneously displaying still-frame images forming a moving image in time sequence.

4. An image display apparatus according to claim 1 wherein the image display means are each capable of instantaneously displaying still-frame images based on image information given as electrical information.

5. An image display method for a vehicle, including the steps of:
placing a plurality of image display means in a row at specific intervals along a moving direction of the vehicle, each being capable of instantaneously displaying a still-frame image;
placing a first velocity detection means for detecting a velocity of the vehicle near the foremost part of the row of the image display means and placing a second velocity detection means for detecting a velocity of the vehicle near the rearmost part of the row of the image display means; and
controlling timing of display of the still-frame images by the image display means, based on the velocity obtained by the first velocity detection means and the velocity obtained by the second velocity detection means.

6. An image display apparatus for a vehicle, comprising:
a plurality of image display means placed in a row at specific intervals along a moving direction of the vehicle, each being capable of instantaneously displaying a still-frame image;
a first velocity detection means, placed near the foremost part of the row of the image display means, for detecting a velocity of the vehicle;
a second velocity detection means, placed near the rearmost part of the row of the image display means, for detecting a velocity of the vehicle;
a switch means for switching information to output from first velocity information obtained by the first velocity detection means to second information obtained by the second velocity detection means when the difference between the first velocity information and second velocity information falls within a specific range in accordance with a movement of the vehicle; and
a means for generating and outputting a signal for controlling timing of displaying the still-frame images by the image display means, based on the first velocity information or the second velocity information selected and outputted by the switch means.

7. An image display apparatus according to claim 6, further comprising a means for determining whether the velocity information outputted from the first and second velocity detection means is valid or not; wherein
the velocity information that is determined as valid by the means for determining is only inputted to the switch means to effect switching.

8. An image display apparatus according to claim 6 wherein the image display means are each capable of instantaneously displaying still-frame images forming a moving image in time sequence.

9. An image display apparatus according to claim 6 wherein the image display means are each capable of instantaneously displaying still-frame images based on image information given as electrical information.

10. An image display method for a vehicle, including the steps of:
placing a plurality of image display means in a row at specific intervals along a moving direction of the vehicle, each being capable of instantaneously displaying a still-frame image;
placing a first velocity detection means for detecting a velocity of the vehicle near the foremost part of the row of the image display means and placing a second velocity detection means for detecting a velocity of the vehicle near the rearmost part of the row of the image display means;
switching information to output from first velocity information obtained by the first velocity detection means to second information obtained by the second velocity detection means when the difference between the first velocity information and the second velocity information falls within a specific range in accordance with a movement of the vehicle, and outputting the second information; and
generating and outputting a signal for controlling timing of displaying the still-frame images by the image display means, based on the first velocity information or the second velocity information outputted.
